(19) United States
(12) Patent Application Publication
(10) Pub. No.: US 2026/0328035 A1
(43) Pub. Date: Oct. 22, 2026

(54) ROLL SYSTEM FOR PANEL DOOR

(71) Applicant: RIDGE CORPORATION, Pataskala, OH (US)

(72) Inventors: Gary Alan Grandominico, Galena, OH (US); Raymond Augustus McDonald, Pooler, GA (US); Bret Jameson Moss, Lewis Center, OH (US); Zachary Rittler, Pataskala, OH (US)

(21) Appl. No.: 19/654,279

(22) Filed: Apr. 21, 2026

Related U.S. Application Data
(60) Provisional application No. 63/791,819, filed on Apr. 21, 2025.

(51) Int. Cl. E05D 15/16; B60J 5/10; B60J 5/12

(52) U.S. Cl. CPC E05D 15/165; B60J 5/108; B60J 5/12

(57) ABSTRACT

A panel door that includes a front surface, a back surface, a top surface, a bottom surface, and a first side and a second side surface. A roller element is attached to the panel door and is positioned at a side surface, a front surface or a back surface. The roller element has a roller, and the roller has an axis of rotation aligned to be non-parallel or perpendicular to the front exterior surface or the back exterior surface of the panel door.

This application claims priority to and any other benefit of U.S. Provisional Patent Application Ser. No. 63/791,819 filed Apr. 21, 2025, the contents of which are incorporated herein in their entirety by reference.

### TECHNICAL FIELD

An improved roll system for panel doors and, in particular, a roll system that exhibits a horizontal loading force on a panel door or increases stiffness of the door. The roll system includes a panel or roll door having attached roller elements that are designed to fit into a guide for moving the door from an open to a closed position. The roller elements include a roller having a central axis arranged perpendicular to a front or back facing surface of the panel or roll door.

### BACKGROUND

Since the conception of non-moving or moving vehicle roll-upward acting doors of 1930's, 40's, 50's and to present day, storage containers such as transport trailers, truck bodies, containers as well as nonmoving storage containers such as garage doors and commercial storage warehouses, track systems and roller systems have remained relatively unchanged. This includes the rear frame on a moving vehicle/storage container and the framing around a non-moving storage container/house/warehouse.

Roll doors currently utilize a roller bracket secured to the sides of the door to accommodate moving the door upward to open the end of a truck trailer. The rollers in the bracket roll in a track that is secured to the frame of the trailer. The roller bracket, often made of metal, is generally bolted onto the roll door and many roller brackets are used on each side of the door, which adds considerable weight to the roll door making it more difficult to move up and down. Other metal roller types are secured to the sides of a roll door by direct insertion into the door. In addition to adding weight, these roller types create pressure points in the door and can cause damage to the door during operation. The present invention utilizes a portion of the roll door to extend to a roller bracket to reduce a robust bracket being secured to the sides of the door.

In addition, the existing track designs contain rollers that roll at a 90-degree angle relative to the front or rear face of the door or a plurality of door panels. These rollers, mounted typically on the rear face of the door with a rod/shaft attached to a wheel at one end with the rod or shaft extending through a bracket mounted to the rear (internal or cargo side) face of the door do not allow for a tensioning force across the exterior or interior face of the door horizontally when high forces (e.g., freight or wind load) exist. In this configuration, the door frame only allows some tension (load restraint) from top to bottom (vertically) on the door via a bottom locking device for security.

In the present invention the upward/downward acting roll up door roller or rollers are rotated 90 degrees to traditional construction and allows for tensioning of the door across the door face horizontally therefore giving an additional strength for high winds on non-moving doors and a tension surface for higher strength and security on moving vehicles for load constraint. Once a force is applied to the interior or exterior door face, a deflection of the door exists due to force. When the wheels are in a parallel plane to the door panels or skins horizontally and connected through the skins or panels to place the horizontal plane in tension. The attachment of the wheel through the skin/skins through multiple vertically mounted panels or single skin door panels may or may not create immediate tension across the face. Once the panel or continuous skin continues to load by force of wind or force of moving freight a tensioned surface will result. Horizontally tensioned cargo rollup doors may additionally help reduce racking of the door frame. Racking is a condition in which the door frame on moving vehicles sways or comes a parallelogram instead of square. This added measure of security by tensioning the surface allows for loading beyond the capabilities of current rollup door construction for cargo containment and wind loading. Additionally, rollers with rods/shafts and end hinge brackets/covers are eliminated which reduces weight and future maintenance. The end brackets/covers can rust and corrode. The invention places rollers in or on a variety of tracks that contain wheels internally or externally, but the wheels are held in a less corrosive environment at the end of the door.

### SUMMARY

The following is a brief summary of subject matter that is described in greater detail herein. This summary is not intended to be limiting as to the scope of the claims.

In a first aspect, there is disclosed a panel door that includes a front surface, a back surface, a top surface, a bottom surface, and a first side and a second side surface. A roller element is attached to the panel door and is positioned at the first side surface, the roller element has a roller, and the roller having an axis of rotation and the axis of rotation being non-parallel to the front surface or the back surface of the panel door.

In an example of aspect 1, the axis of rotation of the roller is substantially perpendicular to the front surface or the back surface of the panel door.

In another example of aspect 1, the axis of rotation of the roller is substantially parallel to the first side surface or the second side surface of the panel door.

In another example of aspect 1, the roller element is attached to the first side surface of the panel door.

In another example of aspect 1, the panel door is arranged in at least one guide track for positioning the door between a first position and a second position, and the roller of the roller element is positioned in a portion of the guide track.

In another example of aspect 1, the guide track can be a slotted rectangular tube, a slotted square tube, a C-channel, an I-beam or a slotted circular tube.

In another example of aspect 1, the roller element includes two or more rollers, the two or more rollers each having an axis of rotation substantially perpendicular to a panel door front facing direction.

In another example of aspect 1, the roller element includes a mounting portion, the mounting portion of the roller element being attached to the first side surface of the panel door.

In another example of aspect 1, the roller element includes a mounting portion, the mounting portion of the roller element being attached to the front surface or the back surface of the panel door, and the roller of the roller element extends outward from the first side surface for engaging a guide track.

In another example of aspect 1, the roller element includes a plurality of rollers, and one roller of the plurality of rollers has an axis of rotation perpendicular to another roller of the plurality of rollers of the roller element.

In another example of aspect 1, the roller element includes two rollers, the two rollers being connected together with a fastener, the fastener extends through a portion of the panel door at the first side surface.

In another example of aspect 1, the fastener extends through a polymeric skin extending from the first side surface of the panel door.

In another example of aspect 1, the polymeric skin is a fiber-reinforced polymeric skin.

In another example of aspect 1, the polymeric skin forms a portion of the front surface or the back surface of the panel door.

In another example of aspect 1, the panel door is a composite door and/or a single panel door. The panel door can be made of multiple sections secured together with a hinge portion arranged at each joining area of two sections.

In a second aspect, there is disclosed a panel door assembly that includes a set of guide tracks, a panel door configured to roll open and closed in the guide tracks to cover a door opening, the door opening having an entry direction, the panel door having a front surface, a back surface opposite the front surface, a first side surface and a second side surface facing perpendicular to the front surface and the back surface, and a roller element attached to the panel door, the roller element comprising a roller, the roller having an axis of rotation being substantially parallel with the entry direction of the door opening. The panel door is capable of approximating a curvature in the set of guide tracks for positioning the panel door being an open and closed configuration.

In an example of aspect 2, a truck, vehicle or transportation carrier includes the panel door of the second aspect.

In another example of aspect 2, the panel door is a composite door and/or a single panel door.

In another example of aspect 2, the panel door includes a plurality of attached roller elements.

The above aspects (or examples of those aspects) may be provided alone or in combination with any one or more of the examples of that aspect or another aspect discussed above; e.g., the first aspect may be provided alone or in combination with any one or more of the examples of the first aspect, second aspect, third aspect or other aspects discussed above.

The above summary presents a simplified summary in order to provide a basic understanding of some aspects of the compositions, items of manufacture, and/or methods discussed herein. This summary is not an extensive overview of the subject matter discussed herein. Its sole purpose is to present some concepts in a simplified form as a prelude to the more detailed description that is presented later.

### BRIEF DESCRIPTION OF THE DRAWINGS

The present disclosure is better understood when the following detailed description is read with reference to the accompanying drawing. The drawings constitute a part of this specification and include exemplary embodiments of the invention, which may also be embodied in various forms. It is further understood that in instances the aspects of the invention may be shown exaggerated or enlarged to facilitate a particular understanding of the invention.

FIG. 1A shows a panel door in a closed position on a set of guide tracks. The panel door is covering an entry point through the doorway, the entry point having an entry direction to pass through the doorway opening when the panel door is in the open position.

FIG. 1B shows the panel door of FIG. 1A in a transition between a closed position and an open position as the panel door traverses along a set of guide tracks having a curvature portion.

FIG. 1C shows the panel door of FIG. 1A in an open position on a set of guide tracks that uncovers the entry point through the doorway.

FIG. 2 shows a perspective view of an example of an exploded view of a portion of a roll system with multiple roller elements for attachment to a roll door.

FIG. 3 shows a perspective view of an assembled portion of the roll system illustrated in FIG. 2 attached to the roll door.

FIG. 4A shows top cross-section portion view of a side of the roll door and roll system of FIG. 2.

FIG. 4B shows top cross-section portion view of a side of the roll door and roll system of FIG. 2.

FIGS. 5A, 5B and 5C show a perspective view of a variety of example guide tracks for use with a roll system for a panel or roll door.

FIG. 6 shows a perspective view of an example of a roller element for attachment to a roll door and use in a roller system.

FIG. 7 shows a perspective view of an example of a roller element for attachment to a roll door and use in a roller system.

FIG. 8 shows a perspective view of an example of a roller element for attachment to a roll door and use in a roller system.

The above examples or aspects may be provided alone or in combination with any one or more of the examples discussed above; e.g., the a first example may be provided alone or in combination with any one or more of the remaining examples or other aspects discussed above.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### DETAILED DESCRIPTION

The terminology as set forth herein is for description of the embodiments only and should not be construed as limiting the invention as a whole. Other advantages of the invention are apparent from the descriptions, in combination with the drawings, whereby by way of illustration and example embodiments of the invention are disclosed.

Herein, when a range such as 5-25 (or 5 to 25) is given, this means preferably at least or more than 5 and, separately and independently, preferably not more or less than 25. In an example, such a range defines independently 5 or more, and separately and independently, 25 or less.

The present disclosure relates to a roll system in use with a panel door. Panel doors can include roll doors that bend or flex when traversing between an open and closed position. Any suitable type of panel door is used with the roll system, for instance, a single-panel or multi-panel doors. Panel doors that include or are substantially made of composite materials are suitable for use with the roll systems. Panel doors made with other materials or combinations of material (e.g., wood, metal, glass, etc.) are also suitable for use with the roll system.

Panel doors for use with the roll system can be installed in any suitable application. For instance, panel doors include garage doors for industrial or residential applications. Panel doors can also include those suitable for storage or transportation applications, such as a transportation container, storage unit, trailer, refrigeration unit, recreational tailer or vehicle, or the like.

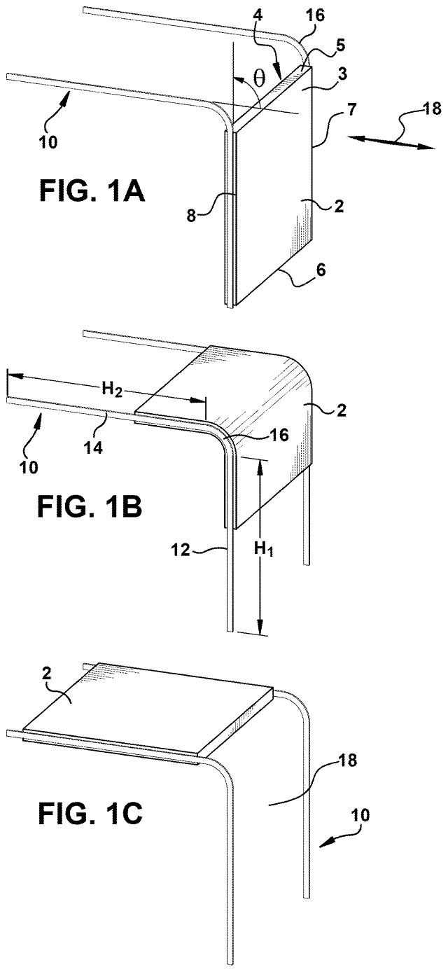

Turning to the figures, as shown in FIGS. 1A-1C, the panel door 2 is arranged on a set of guide tracks 10 having a curvature 16 for transitioning the panel door from a closed position shown in FIG. 1A to an open position shown in FIG. 1C. The curvature 16 is approximately 90 degrees, but can range from 80 degrees to 125 degrees. On either side of the curvature portion 16 of the tracks 10, the guide tracks have straight portions 12, 14 approximately the length of the door height, shown as portions H₁ and H₂.

The panel door 2 is designed to traverse along curvature 16 in the set of guide tracks 10 by flexing and/or bending to approximate the curvature as shown in FIG. 1B. The panel door 2 has multiple roller elements attached with rollers that are arranged in the set of guide tracks 10 to move the door along the tracks to open a doorway entry, for example, that can have an entry and exit direction 18 perpendicular to the front surface 3 of panel door 2. Opposite the front surface 3 is a back surface 4. The panel door 2 further includes a top surface 5, a bottom surface 6, a first side 7 and a second side 8. In the open position, the panel door 2, or most of the door, is substantially horizontal, and in the closed position, the panel door 2, or most of the door, is in a substantially vertical position as shown.

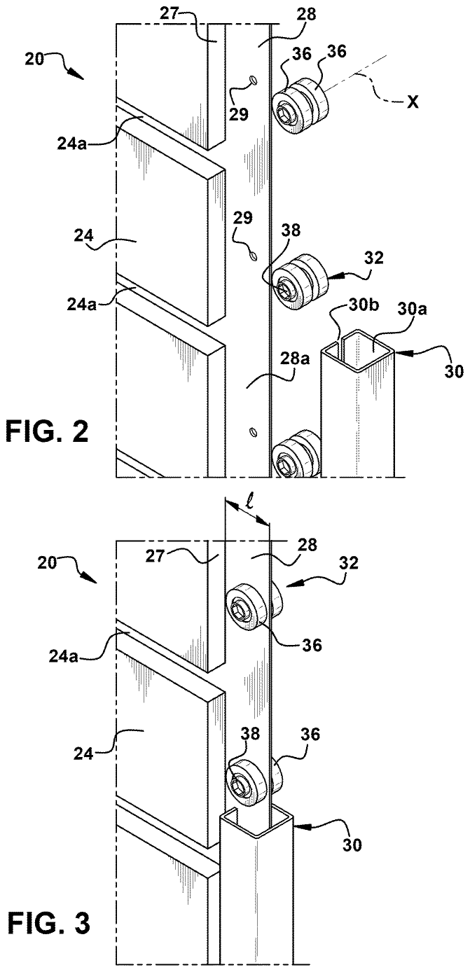

An example of the panel door 20 is shown in FIG. 2, along with components of a roller element 32. As shown, a portion of the back surface 24 and first side surface 27 of the door 20 are exposed. The back surface 24 of the door has multiple cutout portions 24a for making the door 20 more flexible during operation, for example, for traversing along a curvature of a set of guide tracks. Although the back surface 24 of the door 20 is not a single flat surface, it is defined as being substantially flat in areas, for instance, for 50, 60, 70, 80 or 90 or more percent of the surface area of the back face of the door. Not shown as being exposed, the door 20 has a front surface facing opposite back surface 24. Door 10 has a first side surface 27 that extends along the height of the door from the top surface to the bottom surface. The first side surface 27 has at least a portion perpendicular to the back 24 and front surfaces of the door 20.

Extending from the first side surface 27 is a wing portion 28 for attaching roller element 32. As shown, wing portion 28 extends from the first side surface 27 parallel to the front surface and back surface of door 20. Wing portion 28 can have one or more, or a plurality, of apertures 29 for attaching a roller element 32 to the door 20, and in particular to a first and second side surface or adjacent a first and second side surface if a wing portion 28 extends outward from a side surface of the door. Apertures 29 extend through the wing portion and can accommodate components (mounting bracket, fastener, coupling, pin, etc.) of the roller element 32. The apertures can be spaced apart along the side of the door from the top surface to the bottom surface as shown in FIG. 2. As depicted, the roller element 32 has two rollers 36 secured together with a fastener 38. A portion of the fastener can pass through aperture 29 to attached roller element 32 to wing portion 28 of door 20. As attached to the door 20, one roller 36 is positioned each side of wing portion 28.

The two rollers 36 of roller element 32 have the same central axis of rotation X, which as shown in FIGS. 2 and 3, is perpendicular or substantially perpendicular to the front surface and back surface 24 of door 20. The axis of rotation X of the rollers 36 also is perpendicular to the back face 28a and front face, opposite of back face 28a, of wing portion 28. Rollers of the prior art are arranged to have an axis of rotation perpendicular to the rollers of the present invention. Rollers of the present disclosure can also be made of any suitable material, for example, metal, plastic, ceramic, polymers, rubber, silicone and the like as known in the art.

Roller element 32, fastener 38 and rollers 36 are configured to fit into the internal housing area 30a of guide track 30. Guide track 30 has a square frame defining the internal housing area that is open for introducing the roller element 32, and guide track 30 also has an open seam or slot 30b in the frame along a portion of its length or, alternatively, along its entire length for accommodating movement of the panel door 20. The open seam 30b has a suitable width for fitting any portion of the roller element 32 that must extend out of the internal housing area 30a towards panel door 20 and/or any portion of panel door 20 that must extend into internal housing area 30a, such as wing portion 28 as shown in FIG. 3. Open seam 30b is preferably wide enough to allow smooth movement of roller element components and/or panel door components during operation of the panel door, for instance traversing between a closed and open position, but not overly wide such that debris and other materials easily enter the internal housing area 30a that would degrade or prevent efficient movement of the panel door 20 along the guide tracks 30.

The panel door 20 as shown in FIGS. 2 and 3 is a composite door. The front surface and back surface of door 20 are made of polymeric skins. For instance, the front surface of the door can be made of an outer polymeric skin and the back surface, or a significant portion thereof, can make up the back surface 24 of the door. As shown in FIGS. 2 and 3, the back surface 24 can have cutout portions 24a in the inner polymeric skin that exposes internal materials of the composite door, for example, core material or the outer polymeric skin.

The polymeric skins used for the front and back wall surfaces of the door may be the same material. The polymeric skins may form the entire front and back wall surfaces such that the wall surfaces are a continuous surface along their width, height or a combination of both. The skins include a polymeric material, which can be the sole material, excluding any fiber reinforcement, that forms the skins. The polymeric material can be a single sheet that forms an outermost surface, for example front surface or back surface, of the composite panel door. The polymeric material can include a thermoplastic material. Polymeric material can include, but is not limited to, polypropylene, polyethylene, poly vinyl chloride, polycarbonate, polyacrylic, polymethylmethacrylate, polystyrene, and combinations thereof. The polymeric or thermoplastic material of the inner or outer polymeric skin can be reinforced to strengthen the material and provide rigidity to the wall surfaces of the composite wall structure.

Reinforcement materials for the polymeric skins can include fibers, for example, continuous, discontinuous, or chopped fibers. Fibers can include any suitable fiber or combination of fibers, for instance, glass, polyamide, polyester, cellulose, carbon, aramid and the like. The outer polymer skin, and the inner polymeric skin, can be single layer or two or more layers laminated together (e.g., a multilaminate layer) as desired.

The composite panel door can further include a core material positioned in the central area between the inner and outer polymeric skins that form the wall surfaces (front and back) of the composite panel door. The core material provides integral strength and rigidity to the wall and, in instances, insulating properties, without resulting in significant weight increase. The core material is sandwiched between portions of the inner polymer skin and the outer polymeric skin. In some embodiments, the core material is adhered directly to the inner polymeric skin, the outer polymeric skin, or both skins. Any suitable adhesive or bonding agent can be used to adhere the core material to the skins. In another example, the core material and skins can be formed together by thermoforming the composite panel structure of the door. In other examples, the core material can be constructed of continuous or discontinuous sections that are positioned in the center of the wall height and in between the inner and outer skins providing the desired finished thickness of the composite panel door.

The core material can be any suitable material, for example, a honeycomb or a foam. Examples of a foam can include, for instance, closed cell foams (ethylene vinyl acetate foam), polyethylene foams, polypropylene foams, and neoprene foams, and open cell foams such as polyurethane or polyether- or polyester-based polyurethane foams.

Turning back to FIGS. 2 and 3, wing portion 28 is an extended portion of the outer polymeric skin forming the front surface of door 20 such that the outer polymeric skin extends past the first side surface (and second side surface not shown) of the door to form a structure for mounting roller elements 32. By extending a material of the door such as the outer polymeric skin to form an area for mounting roller elements, the area has improved structural integrity and minimizes use of additional components and/or other materials.

In another embodiment, roller elements can be attached to a first and second side surface of the door. In other embodiments, roller elements can be attached to, optionally in addition to attachment to the first or second side surface, the front surface, back surface or a combination of both surfaces of the door. Attaching roller elements to the door can include clips, bolts, rods, screws, fasteners, adhesives, clamps, pressure fittings, etc. as known in the art. In other examples, a portion of the roller elements can be embedded into a portion of the door material, such as a core material sandwiched between two polymeric skins, for attaching the roller elements to the door.

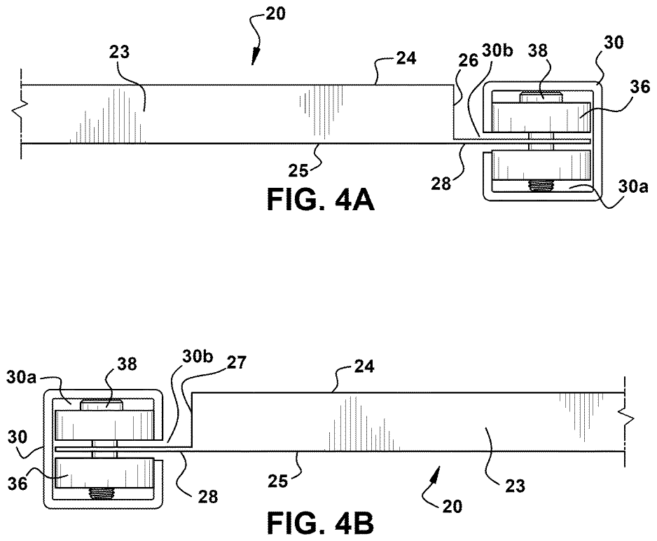

FIGS. 4A and 4B show two cross-section views of a portion of panel door 20 of FIGS. 2 and 3, one view that includes a first side surface and one view that includes a second side surface. For sake of simplicity, only FIG. 4A is described below and it is appreciated that FIG. 4B has a similar arrangement of an opposite side of panel door 20.

FIG. 4A shows the second side surface 26 of panel door 20 that is between inner polymeric skin 24 and an outer polymeric skin 25. Positioned between the polymeric skins 24, 25 is core material 23. Core material 23 can be exposed at the first and second side surfaces 25, 26 of the door 20 along with an edge of the sandwiching inner and outer polymeric skins 24, 25. In other examples, a portion of the inner or outer polymeric skins may wrap around the edge of a front or back surface of the door to cover core material at the side surface so that it is not exposed. As shown, wing portion 28, adjacent second side surface 26, extends from front surface 25 of the door formed by the outer polymeric skin. Attached to wing portion 28 is roller element 32 secured with fastener 38 passing through wing portion 28 to position a single roller 36 on each side of portion 28.

Entire roller element 32, and part of wing portion 28, is positioned within internal housing area 30a, while a section of wing portion 28 extends through open seam 30b oriented to face the side surface of door 20. Rollers 36 press against at least one surface of the internal housing area 30a of guide track 30 to operate and move panel door 20 along the guide track 30. Rollers 36 are oriented in guide track 30 to rotate about an axis of rotation that is at least one of being parallel to first and second side surface 26, 27 and perpendicular to front and back surface 24, 25. The outer diameter surface of rollers 36 further rotate and can face towards first and second side surfaces 26, 27 of panel door 20. Each side of the rollers, between the outer diameter and inner diameter, faces in the direction of the front or back surfaces 24, 25 of panel door 20, and also towards one of the surfaces of wing portion 28.

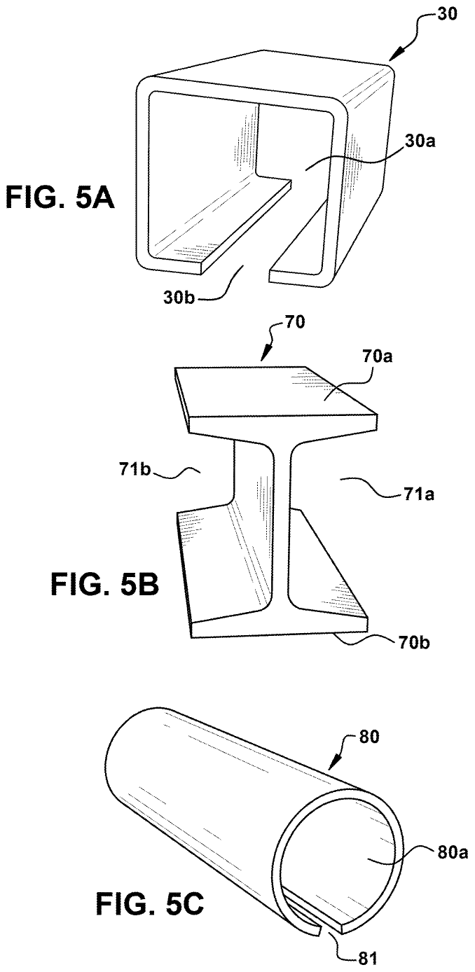

As shown, guide track 30 of FIGS. 4A and 4B has a square-shaped cross-section defining the internal housing area 30a. The guide track 30 can be sized as suitable to house different designs and sizes of roller elements. Other cross-section shapes of guide tracks may be used to house or engage roller elements that may be used with the panel door for operating and moving it between open and closed positions. For example, FIGS. 5A through 5C are designs of guide tracks that can be used with the present invention. FIG. 5A shows a square or rectangular guide track having an open seam for accommodating roller element parts and/or panel door portions during operation of the panel door. Guide tracks for use with the panel door can be made of any suitable material, for example, metal, plastic, reinforced polymers or rubbers.

FIG. 5B shows an I-beam guide track 70 for use with the panel door. The I-beam guide track 70 can be used with the roller element 50 as depicted in FIG. 7. Roller element 50 includes a U-shaped bracket 51 having two ends 51a, 51b for attaching at least one roller 56. At the other end of the U-shaped bracket 51, a mounting portion 52 extends in an opposite direction as the ends 51a, 51b of the roller element 50. Mounting portion 52 can be attached to wing portion 28 of the panel door 20, for instance, mounting portion 52 can be clamped or bolted onto wing portion 28 such that ends 51a, 51b of U-shaped bracket 51 face away from a first or second side surface of the door.

Rollers 56 mounted on ends 51a, 51b are angled outward away from one another at the roller portion furthest from U-shaped bracket 51 and angled towards one another at the roller portion closest to the U-shaped bracket 51. The angled position of rollers 56 can engage and roll along channels 71a, 71b of I-beam guide track 70 for operating the panel door. I-beam guide track 70 can be arranged such that one end 70a, 70b faced the side surface of the panel door and the end 70a, 70b facing closest to the side surface 26, 27 of the panel door 20 can be positioned in the center area of the U-shaped bracket 51 between rollers 56 and bottom portion 51c. The I-beam guide track 70 avoids having an internal housing area for securing roller elements, which can ease the costs and time associated with maintenance and repair of a roller system.

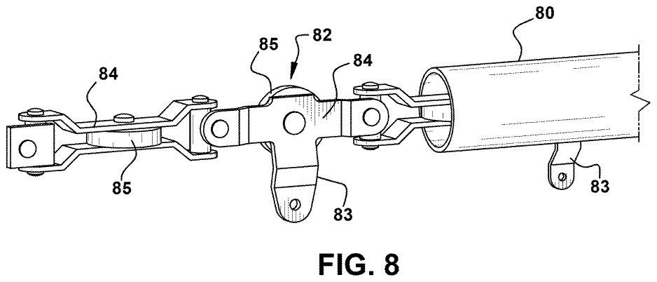

Another example of a guide track is shown in FIG. 5C. Slotted circular guide track 80 has an open slot or seam 81 extending along its entire length or a portion thereof, and the open seam 81 is oriented to face the side surface of door 20. As shown, guide track 80 circular-shaped cross-section defining the internal housing area 80a. The guide track 80 can be sized as suitable to house different designs and sizes of roller elements. In a similar design as square-shaped guide track 30, circular track 80 can house an entire roller element, and if needed part of a wing portion of the panel door, within internal housing area 80a. A section of wing portion 28 extends through open seam 81 facing the side surface of the door. Rollers of a roller element housed in guide track 80 press against the surface of the internal housing area 80a of guide track 80 to operate and move panel door 20 along the guide track 80. An example roller element for use with hollow circular guide track 80 is shown in FIG. 8.

FIG. 8 shows a roller element 82 having a linked body that includes roller brackets 84 attached together in a series. Each roller bracket 84 is attached to at least one adjacent roller bracket 84, and in certain instances two roller brackets 84, by a fastener such as a bolt, pivot joint, clip or the like. Each roller bracket 84 includes at least one roller 85 for accommodating movement of the panel door along the length of the guide track 80. Roller brackets 84 can orient the one or more rollers 85 relative to the panel door, for example, the front or back surface of the panel door, the first or second side surface of the panel door, the front facing direction of the panel door, or the entry direction of a door opening formed by positioning or moving the door from an open position to a closed position.

Each roller 85 has an axis of rotation. FIG. 8 shows multiple rollers 85 with a series of rollers 85 having an axis of rotation that is perpendicular to other rollers in the chain of roller elements. The chain of roller elements 82 can have alternating rollers 85 with an axis of rotation being perpendicular to an adjacent roller 85. In other embodiments, one or more rollers 85 of the chain of roller elements, or a plurality of rollers 85, and also rollers in other roller elements of the present disclosure, can be arranged to be perpendicular or non-parallel to one or more of the following the front or back surface of the panel door, the first or second side surface of the panel door, the front facing direction of the panel door, or the entry direction of a door opening formed by positioning or moving the door from an open position to a closed position.

As shown, a roller element 82 can include a mounting portion 83 for securing the roller element 82 to the panel door, for example at or near a side surface of the door. The mounting portion 83 extends from the roller bracket 84 and can be positioned to extend outward through a slot or seam in the circular guide track 80. For attachment to the panel door, mounting portion 83 can be attached to wing portion of the panel door 20, for instance, mounting portion 83 can be clamped or bolted onto wing portion 28 as shown in FIGS. 4A, 4B. In other examples, mounting portion 83 can be secured to a front or back surface of the door near the first or second side surfaces. In yet another example, mounting portion 83 can be embedded in a side surface of the panel door.

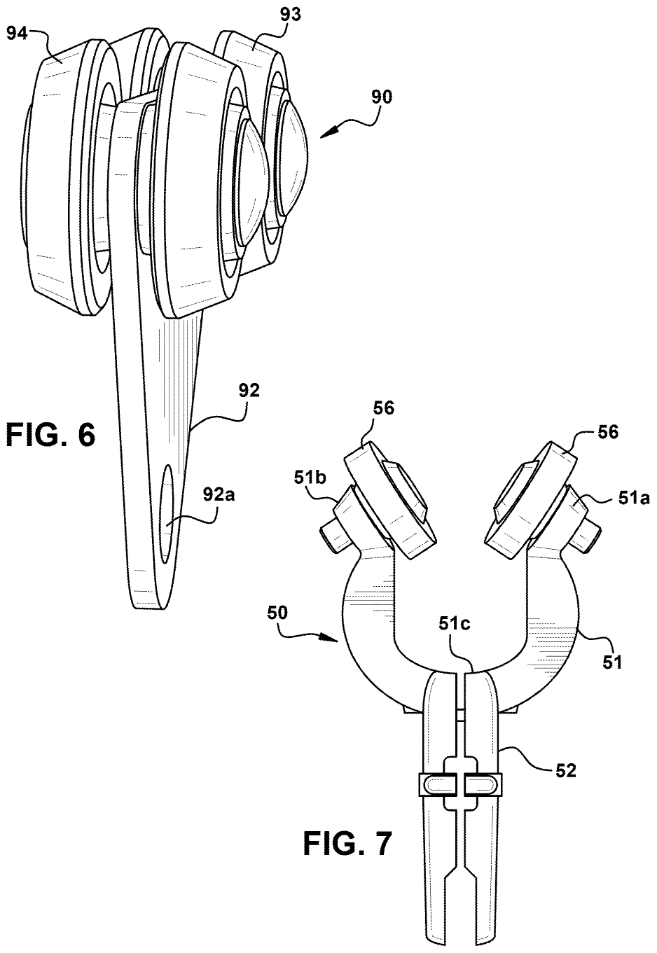

FIG. 6 illustrates another example of a roller element 90 for use with a panel door. As similar to the other example roller elements, roller element 90 has a mounting portion 92 for attachment to a panel door. The mounting portion 92 can extend from the roller bracket 90 and can be positioned to extend outward through a slot or seam in a guide track, for example, a guide track shown in FIGS. 5A, 5C. The entire roller element 90, excluding the section of mounting portion 92 extending out of the guide track, is positioned within internal housing area of a guide track. Rollers 93, 94 press against at least one surface of the internal housing area of a guide track to operate and move panel door along the guide track.

Attachment to the panel door can include at or near a side surface of the door, for instance, on an exterior surface of the door. Mounting portion 92 can have an aperture 92a for attaching the roller element 90 to the panel door, such that a fastener like a screw or bolt can pass through aperture 92a and into a surface of the panel door. In other examples, mounting portion 92 can be attached to wing portion of the panel door 20, for instance, mounting portion 92 can be clamped or bolted onto wing portion 28 as shown in FIGS. 4A, 4B. In other examples, mounting portion 92 can be secured to a front or back surface of the door near the first or second side surfaces. In yet another example, mounting portion 92 can be embedded in a side surface of the panel door.

At the opposite end of the mounting portion 92, the roller element 90 can one or more pairs of rollers, such as two, three or four pairs of rollers. As shown, roller element 90 includes two pairs of rollers 93, 94 secured to one end of the element. Each pair of rollers 93, 94 has an axis of rotation about their center. The axis of rotation of each pair of rollers 93, 94 can be arranged to be perpendicular or non-parallel to one or more of the following the front or back surface of the panel door, the first or second side surface of the panel door, the front facing direction of the panel door, or the entry direction of a door opening formed by positioning or moving the door from an open position to a closed position. The orientation of rollers 93, 94 relative to the exterior surfaces of the panel door can be as shown for rollers 36 of FIGS. 2, 3, 4A, 4B having an axis of rotation X.

Rollers 93, 94 can be arranged next to one another such that the axis of rotation of each pair of rollers is aligned in the same plane as shown in FIG. 8. Rollers 93, 94 can be spaced apart from one another at any suitable distance, preferably equally spaced away from a center of mounting portion 92. In other embodiments, the rollers of each pair of rollers can be of the same size or diameter such that movement through a guide track is consistent and balanced.

Other alterations or changes to the designs of the embodiment of FIGS. 1 through 8 can also be made. While the invention has been described in connection with various detailed embodiments and figures, the description is not intended to limit the scope of the invention to the particular forms set forth herein, but on the contrary, it is intended to cover such alternatives, modifications, and equivalents as may be included within the spirit and scope of the invention as defined by the appended claims.

1. A panel door comprising a front surface, a back surface, a top surface, a bottom surface, and a first side and a second side surface,
wherein a roller element is attached to the panel door and is positioned at the first side surface, the roller element comprising a roller, the roller having an axis of rotation and the axis of rotation being non-parallel to the front surface or the back surface of the panel door.

2. The panel door of claim 1, wherein the axis of rotation of the roller is substantially perpendicular to the front surface or the back surface of the panel door.

3. The panel door of claim 1, wherein the axis of rotation of the roller is substantially parallel to the first side surface or the second side surface of the panel door.

4. The panel door of claim 1, wherein the roller element is attached to the first side surface of the panel door.

5. The panel door of claim 1, wherein the panel door is arranged in at least one guide track for positioning the door between a first position and a second position, and the roller of the roller element is positioned in a portion of the guide track.

6. The panel door of claim 5, the guide track being selected from the group consisting of a slotted rectangular tube, a slotted square tube, a C-channel, an I-beam or a slotted circular tube.

7. The panel door of claim 1, wherein the roller element comprises two or more rollers, the two or more rollers each having an axis of rotation substantially perpendicular to a panel door front facing direction.

8. The panel door of claim 1, wherein the roller element comprises a mounting portion, the mounting portion of the roller element being attached to the first side surface of the panel door.

9. The panel door of claim 1, wherein the roller element comprises a mounting portion, the mounting portion of the roller element being attached to the front surface or the back surface of the panel door, and the roller of the roller element extends outward from the first side surface for engaging a guide track.

10. The panel door of claim 1, wherein the roller element comprises a plurality of rollers, and one roller of the plurality of rollers has an axis of rotation perpendicular to another roller of the plurality of rollers of the roller element.

11. The panel door of claim 1, wherein the roller element comprises two rollers, the two rollers being connected together with a fastener, the fastener extends through a portion of the panel door at the first side surface.

12. The panel door of claim 11, wherein the fastener extends through a polymeric skin extending from the first side surface of the panel door.

13. The panel door of claim 12, wherein the polymeric skin is a fiber-reinforced polymeric skin.

14. The panel door of claim 12, wherein the polymeric skin forms a portion of the front surface or the back surface of the panel door.

15. The panel door of claim 1, wherein the panel door is a composite door.

16. The panel door of claim 1, wherein the panel door is a single panel door.

17. A panel door assembly comprising:
a set of guide tracks;
a panel door configured to roll open and closed in the guide tracks to cover a door opening, the door opening having an entry direction, the panel door comprising a front surface, a back surface opposite the front surface, a first side surface and a second side surface facing perpendicular to the front surface and the back surface; and
a roller element attached to the panel door, the roller element comprising a roller, the roller having an axis of rotation being substantially parallel with the entry direction of the door opening;
wherein the panel door is capable of approximating a curvature in the set of guide tracks for positioning the panel door being an open and closed configuration.

18. A truck comprising the panel door assembly of claim 17.

19. The panel door assembly of claim 17, wherein the panel door is a single panel door.

20. The panel door assembly of claim 17, wherein the panel door comprises a plurality of attached roller elements.
